(19) United States
(12) Patent Application Publication
(10) Pub. No.: US 2020/0413125 A1
(43) Pub. Date: Dec. 31, 2020

(54) INTERACTIVE VISUAL INFORMATION SYSTEM

(71) Applicant: Marques Brandon Roberson, Missouri City, TX (US)

(72) Inventor: Marques Brandon Roberson, Missouri City, TX (US)

(21) Appl. No.: 16/946,564

(22) Filed: Jun. 26, 2020

Related U.S. Application Data
(60) Provisional application No. 62/868,002, filed on Jun. 28, 2019.

(51) Int. Cl. H04N 21/431; H04N 21/435; H04N 21/472; H04N 21/8545; H04N 21/2187; G06Q 30/02

(52) U.S. Cl. CPC H04N 21/4316; H04N 21/435; H04N 21/47217; H04N 21/812; H04N 21/2187; G06Q 30/0277; H04N 21/8545

(57) ABSTRACT

Embodiments of the present disclosure provide techniques for injecting real-time interactive content into multimedia content feeds by dynamically resizing the display space. It provides a hierarchy of interactive elements that enable real-time interaction with media content during playback. The visual continuity and interaction from the viewer allows the viewer to focus the attention to the media content. The viewer may also pause the media content so that the playback of the media content may be resumed upon completion of the interaction between the viewer and the graphical user interface. In one embodiment, a viewer may engage in the interaction during broadcast of a live television program. In another embodiment, a viewer may engage in the interaction during playback of video on demand.

### CLAIM OF PRIORITY

This application claims the benefit of U.S. Provisional Application Ser. No. 62/868,002, filed Jun. 28, 2019, entitled “Interactive Visual Information System,” the content of which is incorporated herein by reference in its entirety.

### TECHNICAL FIELD

The present invention relates to network-based multimedia distribution systems and more particularly to techniques for injecting real-time interactive content into multimedia content feeds.

### BACKGROUND

Online marketing provides opportunities for retailers to market their products in a greater level. Because online marketing can reach out to anyone in the world with internet access, it has greater potential than selling products through brick and mortar stores. Conventional multimedia marketing has focused on researching consumer behaviors and spending habits and delivering commercials for products expected to be of interest to target consumers to prompt the consumers to purchase the advertised product(s).

One form of conventional multimedia marketing is online marketing, which commonly utilizes pop up advertising. Pop-up advertising is commonly used to present advertisements to consumers through a web browser, where a commercial suddenly appears in a new browser window for viewing by consumers. In general, consumers do not like pop-up advertising because it is unwanted and intrusive. This is because pop-up advertisements often interfere with the consumer's ability to view a program or other content, and many times consumers have no choice but to keep the pop-up open and let the advertisement play out in order to continue viewing the program (e.g., if the user closes the pop-up playback of the program is terminated). Another disadvantage of pop-up advertisements is that the viewer's attention is diverted from the screen, hoping to get back to the program (e.g., the viewer does not even pay attention to or view the content associated with the pop-up).

In another example, there are advertisements that appear while a person is using a music streaming service (i.e., Pandora, Spotify, etc.). In this type of advertisement, the music the audience is licensing to stops, and the music is replaced by an advertisement. Although this type of advertisement is effective in getting attention of the consumers, it interferes with the music being played and may deter the listener from paying attention to or taking interest in the advertisement. Another problem with this type of advertisement is that the user of the music streaming service is stuck with the pre-determined advertisement chosen by the music application.

Some multimedia platforms provide interactive elements that allow the user interact with presented multimedia content. For example, a user may be presented with video navigation choices during display of multimedia content. Such choices enable the user to navigate from one point of video to another point of video (i.e., skipping introduction, fast forward operations, etc.). While this type of video operation allows the user to interact with the displayed multimedia content, such operations are limited to navigation operations and do not allow interaction with external content (i.e., content other than the video being played).

There are services such as Apple TV, Roku and Amazon Fire TV, that offer somewhat interactive information to viewers. For example, Amazon Prime Videos offers a feature called X-ray. This service enables the viewer to obtain extra information on what they are watching (i.e., bios, facts, trivia, etc.). Although this is helpful, such techniques are still restrictive since the message proceeds in one direction (i.e., from network to audience). Additionally, this technique stops playback of the program the viewer is watching, while the additional information is being displayed.

Another problem arises from technical factors (i.e., incompatible formats, hardware requirements, etc.) that limit the commercial entities to work together to with the networks to deliver products and services to the consumers. For example, if a commercial entity wants to start a marketing campaign, it would have to submit different variations of their commercials that would satisfy the formatting requirements of the different media providers. This extra process would cost the commercial entity time and money.

### SUMMARY

This invention provides techniques for injecting real-time interactive content into multimedia content feeds by dynamically resizing the display space in the media content. It provides a hierarchy of interactive elements that enable real-time interaction with media content during playback. The visual continuity and interaction from the viewer allows the viewer to focus the attention to the media content. The viewer also has an option to pause the media content so that the playback of the media content may be resumed upon completion of the interaction between the viewer and the graphical user interface. A user may inject dynamic real-time interaction during broadcast of a live television program. The user may also inject dynamic real-time interaction during playback of video on demand.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1A is a block diagram illustrating a system for distributing interactive content in accordance with aspects of the present disclosure;

FIG. 1B depicts exemplary computing architecture for various devices that can be used in connection with computer-implemented method of the present disclosure;

FIG. 1C is a block diagram illustrating general information flow of a system for distributing interactive content in accordance with aspects of the present disclosure;

FIG. 2A is a screen shot illustrating aspects of a graphical user interface providing access to an interactive content distribution system in accordance with aspects of the present disclosure;

FIG. 2B is a screen shot illustrating aspects of graphical user interface that facilitates creation and configuration of icons in accordance with aspects of the present disclosure;

FIG. 2C is a screen shot illustrating aspects of graphical user interface that facilitates creation and configuration of media display space in accordance with aspects of the present disclosure;

FIG. 2D is a screen shot illustrating aspects of graphical user interface that facilitates organization of icons in accordance with aspects of the present disclosure;

FIG. 3 is a screen shots illustrating high-level overview of hiearchial sequence in accordance with aspects of the present disclosure;

FIGS. 4A-4D depict screen shot illustrating dynamic resizing of the display with aspects of the present disclosure;

FIGS. 5A-5D depict examples of locations of the media content displayed with aspects of the present disclosure;

FIGS. 6A-6C depict examples of pluralities of media content displayed with aspects of the present disclosure;

FIGS. 7A-7B depict examples of pluralities of icons with aspects of the present disclosure; and

FIG. 8 is a flow diagram of a method for providing dynamic interaction during display of media content according to aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The present invention will be described below with reference to the drawings. However, this invention may be embodied in many different forms and should not be construed as limited to the embodiments disclosed below. Rather, these embodiments are provided so that this disclosure will be thorough and complete, and will fully convey the scope of the invention to those skilled in the art. Thus, the following detailed description is not to be taken in a limited sense.

Unlike other marketing and advertising tools, where the pop-ups block the display of the media content or prohibit the user from viewing the media content until after the pop-up has finished, the techniques disclosed herein allow the playback of media content to continue while the viewer simultaneously interacts with the content displayed within the display space. Thus, embodiments of the present disclosure maintain visual continuity of media content being displayed while simultaneously enabling interactive media content to be presented to a user.

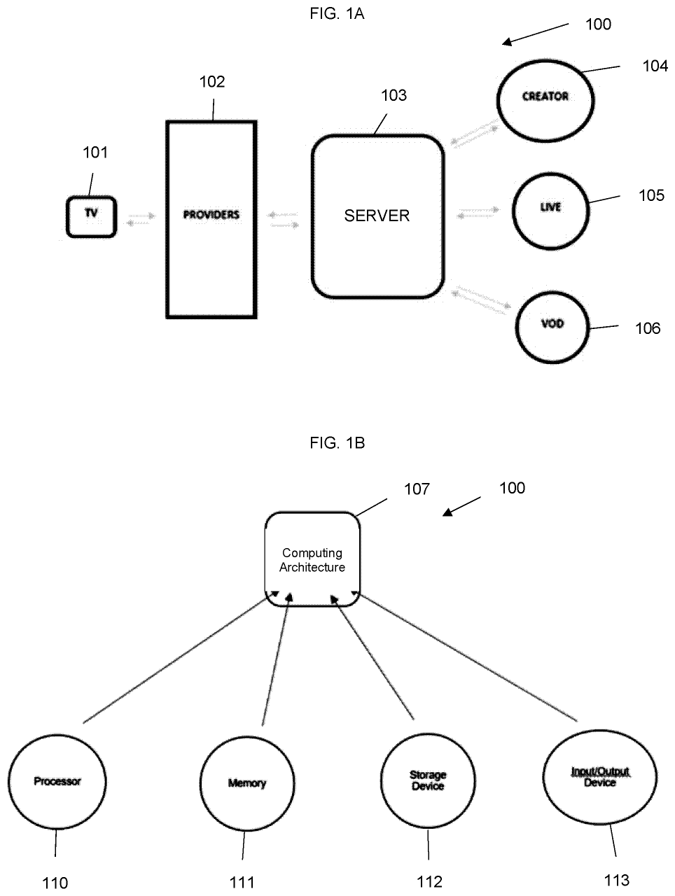

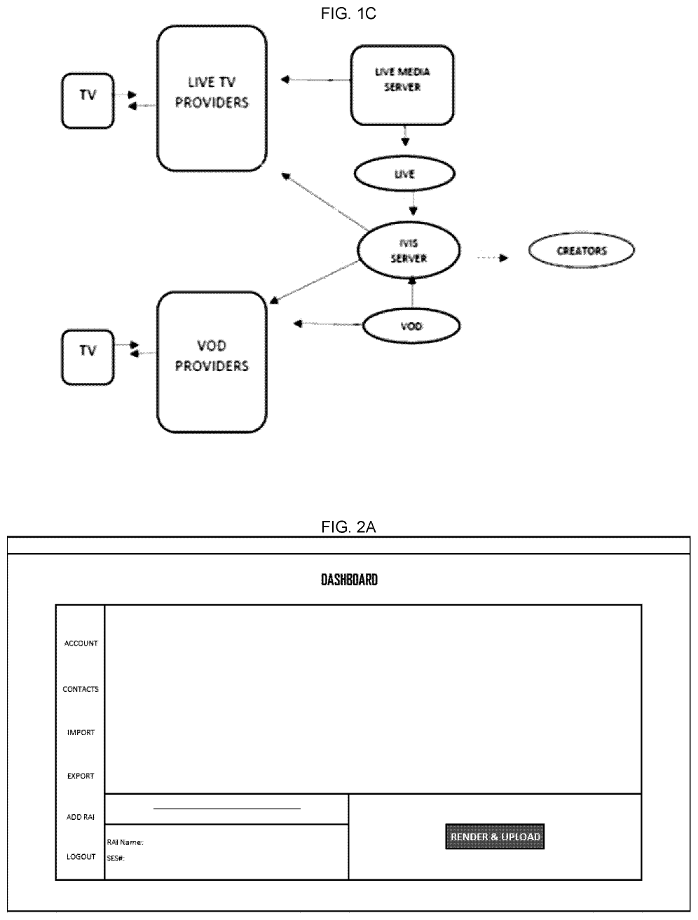

Referring to FIG. 1A, a block diagram illustrating a system for distributing interactive content in accordance with aspects of the present disclosure is shown as a system 100. As shown in FIG. 1A, the system may include Television 101, Providers 102, Server 103, Creator 104, Live 105, and VOD (Video on Demand) 106.

The Providers 102 is referring to cable television/internet providers such as Spectrum, Direct TV, Time Warner, Cox Communications, and others. The Providers 102 may receive media content from the LIVE 105 utilized by television programming companies (e.g., ESPN, CNN, FOX, NBC, and others), then distributes that content to Television 101. The Providers 102 may also receive media contents from VOD 106 utilized by video on demand companies (e.g., Netflix, Disney Plus, and others) then distributes that content to Television 101. The Creator 104 is an entity that creates content that is to be displayed via interaction with RAIs and nSITEs. One example of a creator is a commercial entity that sells products or services. The nSITE is a media content displayed upon dynamic resizing of the display space upon activation by clicking on an icon, referred to herein as a Remappable Action Icon (RAI).

The Live 105 is a platform for distributing live media content utilized by television programming companies. The television programming companies create the media contents and then distribute to Providers 102. The VOD 106 is a platform for distributing video contents utilized by video on demand companies. The video on demand companies distributes the media contents to Providers 102. In many cases, the LIVE 105 and the VOD 106 use the same Providers 102 since many network providers offer both cable and internet services. The Creator 104, Live 105 and VOD 106 may operate on different media content platforms for different functionalities depending on the situation and purpose. In other words, television programming companies may use the LIVE 105 to distribute television contents, while video on demand companies may use the VOD 106 to distribute video contents.

A commercial entity may use the Creator 104 to create an RAI that maybe displayed in the media content to provide dynamic interaction between the commercial entity and users during display of media content. A commercial entity may also create an nSITE which is the media content displayed upon dynamic resizing of the display space. After the creation of RAI and nSITE are complete, the commercial entity may send the information to the Server 103.

A television programming company may import the RAI from the Server 103. This RAI contains all of information the commercial entity has created, including information of nSITE. The television programming company would place the RAI onto an appropriate location of a media content (e.g., live feed that television program is broadcasting). The RAI may be presented as a graphical overlay that is presented simultaneously with the presentation of the TV show content, such as in a corner of the display space. The LIVE 105 may send the information to the Server 103. The LIVE 105 may also send Server 103 time stamps to indicate when the RAI needs to be activated, and according to this schedule the Server 103 may send a media content with activated RAI to the Provider 102.

Likewise, a video on demand company may import the RAI from the Server 103. This RAI contains all of information the commercial entity has created, including information of nSITE. The video on demand company would place the RAI onto an appropriate location of a media content (e.g., a movie that is being streamed online) and send the information to the Server 103. The Provider 102 may retrieve the information from the Server 103 any time prior to the movie being streamed online.

To illustrate, a user may be watching a TV show and during presentation of the TV show content an RAI may be presented to the user. The RAI may be associated with information depicted in the portion of the TV show being displayed, such as to offer information about a meal the characters of the TV show are eating. If the viewer wants more information on the meal (i.e., order the meal and have it delivered, a recipe, etc.) the viewer may click on the RAI. Upon activation of the RAI, the portion of the display space presenting the TV show may be dynamically resized and the information associated with the RAI (e.g., information about the meal the characters are eating) may be presented within a portion of the display space simultaneously with the TV show content. The portion of the display space where the information associated with the RAI may be referred as an nSITE, which is a media content displayed upon dynamic resizing of the display space upon activation of a corresponding RAI. The nSITE may display information associated with the meal, such as the restaurant that prepared the meal, a menu of the restaurant including different types of meals (i.e., regular, deluxe, and premium) sold by the restaurant, a recipe for the meal, or other types of information. The information presented by the nSITE may be interactive, such as to allow the viewer to select a portion of the information to place an order or make a purchase. If the viewer activates one of the interactive elements of the nSITE, a graphical user interface may be presented to allow the viewer to make a purchase based on the activated interactive element. For example, if the viewer activates an interactive element to order the meal that the characters of the TV show are eating, the graphical user interface may present options for the viewer to customize the meal, configure payment information for paying for the order, arrange for delivery or pickup, and the like.

It is noted that throughout the process through which the viewer interacts with the nSITE interface, the media content (e.g., the TV show) may continue to be played. This would allow the television programming companies to keep the attention of the users, while simultaneously enabling interactive media content to be presented. One of the biggest setbacks for allowing advertisers to market their products during broadcasting of media content is keeping the attention of the viewers. By presenting RAIs and nSITEs to the viewers, the viewer's attention is not taken away. However, embodiments may provide an option for the viewer to pause the media content so that the playback of the media content may be resumed upon completion of the interaction between the viewer and the graphical user interface associated with the nSITE. Additional details regarding the above-described processes and the interaction between different service providers to achieve the above-described functionality are described in more detail below.

Referring to FIG. 1B, an exemplary computing architecture for various devices described herein. In aspects, the Provider 102, Server 103, Creator 104, LIVE 105, VOD 106, can all have computing architecture 107 similar to what is shown in FIG. 1B. The computing architecture 107 can be used for the operations described in association with any of the computer-implement methods described previously, according to one implementation. The computing architecture 107 may include a processor 110, a memory 111, a storage device 112, and an input/output device 113.

As shown in FIG. 1B, the system 100 includes computing architecture 107. The computing architecture 107 includes one or more processors 110, a memory 111, a storage device 112 and one or more input/output (I/O) devices 113. The one or more processors 110 may include one or more microcontrollers, application specific integrated circuits (ASICs), field programmable gate arrays (FPGAs), central processing units (CPUs) having one or more processing cores, or other circuitry and logic configured to facilitate the operations in accordance with aspects of the present disclosure.

The memory 111 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality may be stored in the memory 111 that, when executed by the one or more processors 110, cause the one or more processors 110 to perform the operations described herein.

The memory 111 stores instructions that, when executed by the processor(s), cause the processor(s) to perform the operations described in connection with the devices (e.g., Provider 102, Creator 104, LIVE 105, VOD 106, etc.), as described herein The instruction language is to set up computer-readable medium claims and to provide some structure to support method claims being performed by hardware/software, rather than humans (or at least solely by humans).” Additionally, the memory 111 may be configured to store one or more databases. The databases may be used to store advertising content.

The one or more communication interfaces may be configured to communicatively couple the Server 103 to one or more devices (e.g., Providers 102, Creator 104, LIVE 105, VOD 106) via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, and an IEEE 802.16 protocol, a 3rd Generation (3G) communication standard, a 4th Generation (4G)/long term evolution (LTE) communication standard, a 5th Generation (5G) communication standard, and the like). The one or more input/output I/O devices 113 may include one or more display devices, a keyboard, a stylus, one or more touchscreens, a mouse, a trackpad, a camera, one or more speakers, haptic feedback devices, or other types of devices that enable a user to receive information from or provide information to the server 103. It is noted that the exemplary features identified above have been provided for purposes of illustration, rather than by way of limitation.

It is noted that the particular configuration of the system 100 shown in FIGS. 1A-1B have been provided for purposes of illustration, rather than by way of limitation and that embodiments may include additional components (e.g., one or more provider devices, creator devices, set top boxes, video on demand servers, etc.) depending on the particular configuration or implementation of the system 100. Thus, FIGS. 1A-1B are to be understood as illustrating exemplary concepts of the present disclosure.

Referring to FIG. 1C, a block diagram illustrating additional features of system for distributing interactive content in accordance with aspects of the present disclosure is shown. FIG. 1C illustrates a hierarchy of interactive elements that enable real-time interaction with media content during playback.

First Creator 104 creates and assigned RAI and nSITE and send them to the Server 103. Upon receiving notice of the assignment of RAI and nSITE, the LIVE 105 and VOD 106 may import the RAI and place the RAI on the media content. When the placement of RAI onto the media content is complete, the LIVE 105 and VOD 106 send the content back to the Server 103. When someone starts playback of a media content, Server 103 receives a signal, then the server 103 sends Providers 102 media content with appropriate RAIs to be activated.

A viewer may be watching a program on his/her TV set. According to a schedule indicated in time stamps, RAI may be presented on a media content. When the viewer sees an RAI on the items on which he/she is interested, the viewer clicks on the RAI. Upon the activation of an RAI, a portion of the screen slides and create space to display the media content in a display space and then resizing the display space to display the media content in a first portion of the display space while presenting the nSITE content in a second portion of the display space, where the second portion of the display space is created by dynamically resizing the portion of the display space allocated to the media content being played back. The newly displayed information space is called nSITE. There is at least one RAI on the nSITE and the viewer is allowed to navigate within or to another nSITE. For example, the nSITE may present auxiliary media content to the user, which may include additional RAIs, image content, text content, and/or video content. In another example, the nSITE may present auxiliary media content that may correspond to an aspect of the media content being played back (i.e., present a menu for a restaurant characters in the video are eating at) or something that is loosely associated with the media content (e.g., the nSITE content does not directly relate to the media content).

For example, an RAI may be associated with information depicted in the portion of the TV show being displayed, such as to offer information about a meal the characters of the TV show are eating. If a viewer wants to find more information on the meal, the viewer may click on the RAI. The activation of the RAI would dynamically resize the screen, displaying more information on the meal on the nSITE. There may be several RAIs on the nSITE. For example, the RAIs may relate to: types of meal, recipe, and/or maps to the nearest restaurant. If the viewer is interested in purchasing the food, the viewer may clicks on the RAI for the map. It enables the viewer to see a map that shows direction to the restaurants.

The embodiments of the present disclosure maintain visual continuity of media content being displayed while simultaneously enabling interactive media content to be presented to a user. By allowing the viewer to continue to watch the media content, while RAIs and nSITEs enables more user interactions, the attention of the viewer would not be taken away.

In another embodiment, a television programming companies may create a personal profile of a individuals that are involved in the program. For example, ESPN may wish to display player's information in the football team. In such situation, ESPN may use the Creator 104 to create RAIs and nSITEs to display individual players in the team. When this process is complete, ESPN would send the information to the Server 103. ESPN may also use LIVE 105 to obtain RAIs/nSITE information from the Server 103, and places RAI on the appropriate location of the media content. Upon completion of the RAI placement, ESPN would send the information to the Server 103. ESPN may also use the LIVE 105 to send time stamp to the Server 103. The Provider 102 may receive the media content (e.g., football program) from the Server 103 with embedded RAI information.

When the viewer is interested in statistics of certain player, the viewer may click on the RAI placed on the player, then a screen dynamically resizes to show nSITE. The nSITE may show the background information, statistics from prior games, etc. It can also provide an RAI to direct the viewer to various retail store's website that sell merchandise related to the player (e.g., jerseys, memorabilia, and the like).

It is noted that throughout the process through which the viewer interacts with the nSITE interface, the media content (e.g., football game) may continue to be played. This would allow the television programming companies to keep the attention of the users, while simultaneously enabling interactive media content to be presented. By presenting interactive RAIs and nSITEs to the viewers, the viewer's attention is not taken away. However, embodiments may provide an option for the viewer to pause the media content so that the playback of the media content may be resumed upon completion of the interaction between the viewer and the graphical user interface associated with the nSITE.

In another embodiment, ESPN may wish to present team information of upcoming college basketball tournament during a regular college basketball game. In such situation, ESPN may use the Creator 104 to create RAIs and nSITEs to display college team information. When this process is complete, ESPN would send the information to the Server 103. ESPN may also use LIVE 105 to obtain RAIs/nSITE information from the Server 103, and places RAI on the appropriate location of the media content (i.e., basketball game). Upon completion of the RAI placement, ESPN would send the information to the Server 103. ESPN may also use the LIVE 105 to send time stamp to the Server 103. The time stamp may indicate when the commentator would be speaking about the upcoming college basketball tournament during the basketball game. At the appropriate time indicated on the time stamp, the Provider 102 may receive the media content (e.g., basketball game) from the Server 103 with embedded RAI information. If a viewer is interested in teams that are involved in the upcoming college basketball tournament, the viewer may click on the RAI placed on the team in the bracket. The nSITE displayed upon clicking the bracket RAI may include a plurality of additional RAIs that the user may activate to view additional information. The nSITE may show the team's information such as background, statistics from prior games, record, etc. It can also provide an RAI to direct the viewer to various retail store's website that sell merchandise related to the player (e.g., jerseys, memorabilia, and the like). The RAIs may be created for various things related to the content the viewer is watching: tickets for the sports event; hotel reservations; flight reservations; etc.

There are various video file formats (i.e., AVI, MOV, MKV, MP4, AVCHD, FLY, SWF, etc.) and many entities (i.e., commercial entity, television programming companies, video on demand companies, cable/internet provider companies, etc.) may use different formats depending on their situations. These differences may create difficulties in working together efficiently because if one entity used different video format, it needed to be converted to another format so the other company can use the media content. For example if television programming company used different video format from cable/internet providers, the cable/internet provider may convert the format that would be used for their equipment before sending it to the viewers. In the present application, all the entity may use one format by utilizing one program that is used for Creator 104, LIVE 105, VOD 106. Data from the Creator 104, Live 105, and VOD 106 are stored in and distributed through the Server 103. This gives commercial entity the ability to create an advertisement on one platform, and send it to multiple media providers without changing the format.

It is noted that the particular configuration of the system 100 shown in FIG. 1C has been provided for purposes of illustration, rather than by way of limitation and that embodiments may include additional components (e.g., one or more provider devices, creator devices, set top boxes, video on demand servers, etc.) depending on the particular configuration or implementation of the system 100. Thus, FIG. 1C is to be understood as illustrating exemplary concepts of the present disclosure.

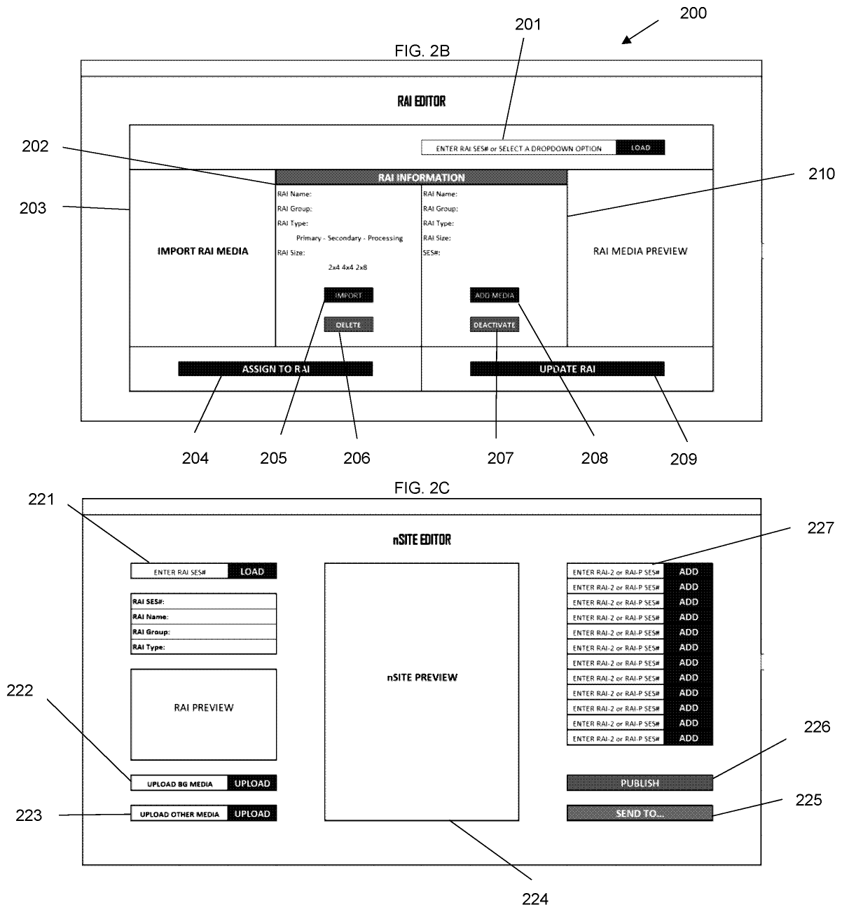

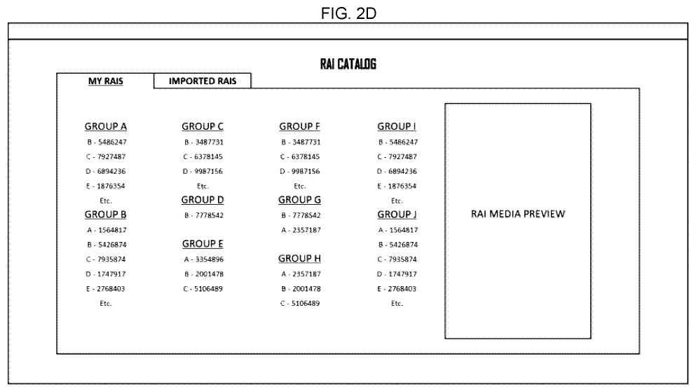

Referring to FIGS. 2A-2D, screenshots illustrating aspects of a graphical user interface that facilitates creation and configuration of RAIs and nSITEs in accordance with aspects of the present disclosure are shown. The Creator 104 is referring to an entity that creates content that is to be displayed via interaction with RAIs and nSITEs. One example of a creator is a commercial entity that sells products or services (i.e., McDonalds, Wendy's, Domino's Pizza, etc.). FIG. 2A illustrates a Dashboard which is the first display space a user sees when logging into the system. This display space may provide general information such as Account information, Contacts, Export, and Logout. From this display space, a user can access RAI Editor 2B to create and/or update RAIs.

In an aspect, there may be three types of RAIs: a Primary RAI, a Secondary RAI, and a Processing RAI. A Primary RAI may be an icon that allows the consumer to access a corresponding nSITE. The nSITE is space that displays new information that is created by dynamic resizing of a display in media content upon activation of a corresponding RAI. When a consumer clicks on a RAI that appears on the screen, a portion of the display slides towards the center (about one third of the display) displaying information.

It is noted that the particular movement of resizing of the display (i.e., towards the center) is provided for purposes of illustrating dynamic resizing of the display space and that other transitions of the media content display space may also be utilized, such as sliding from the right, left, top, bottom, etc. Thus, the movement of the display described here is to be understood as illustrating exemplary concepts of the present disclosure, rather than by way of limitation.

Secondary RAIs may be used to navigate within or to another nSITE. For example, the nSITE may present auxiliary media content to the user, which may include additional RAIs, image content, text content, and/or video content. In another example, the nSITE may present auxiliary media content that may correspond to an aspect of the media content being played back (i.e., present a menu for a restaurant characters in the video are eating at) or something that is loosely associated with the media content (e.g., the nSITE content does not directly relate to the media content). Processing RAIs may be used for payment functions, such as allowing the consumer to purchase products within the nSITE. The Processing RAIs enable communication of data (e.g., payment information) to third party systems. For example, a Processing RAI collects payment information and send it to a credit card processing server to obtain payment authorization. This transmission get routed through Server 103 to third party systems. The Processing RAI may also be used for other financial activities, such as to add the amount to the user's monthly bill.

Referring to FIG. 2B, a screenshot illustrating aspects of graphical user interface that facilitates creation and configuration of icons in accordance with aspects of the present disclosure is shown in 300. There are two sides to the RAI Information. The left box 202 is used to create new RAIs, and the right box 210 is used to modify (i.e., edit, deactivate) the existing RAIs. The top right box 201 allows the user to select existing RAIs for review/preview/editing purposes. For example, the user may have many existing RAIs and can click the Load button to view a folder or directory where the user's RAIs are stored, select one, and load that RAI into the editor interface. The user may click Import 205 on the left box 202 to receive an image from the computer. Alternatively, the user may also click on Import RAI Media 203. After the correct file for the image is selected, the user may input necessary RAI information (i.e., name, group, type, and size). Assign to RAI 204 creates the RAI for use in the system. At this point, a SES (Specific Encoding Sequence) number may be automatically assigned to the RAI. The user may also use Add Media 208 to an RAI (e.g., what will be shown when the RAI is clicked on), which allows the user to change image for the icon used for an RAI. The user may also deactivate the RAI by clicking the button 207. Clicking the update RAI 209 saves the changes.

Referring to FIG. 2C, a screenshot illustrating aspects of graphical user interface that facilitates creation and configuration of media display spaces in accordance with aspects of the present disclosure is shown. The nSITE is the media content displayed upon dynamic resizing of the display space based on activation of a corresponding RAI, and the nSITE editor allows a user to edit/modify the content displayed within the nSITE. As shown in FIG. 2C, when a user wants to add a Secondary or Processing RAI to the nSITE, the user would enter the RAI Specific Encoding Sequence (SES) number on the left top box 221 and click Load.

Then, RAI information (i.e., SES number, name, group, type) that was inputted by the user in the RAI Editor may be filled out automatically by the result of the load, and the image is displayed on RAI Preview. The user can click on Upload BG Media 222 to add a background to the nSITE. Once added, the background may appear on nSITE Preview. For other media (i.e., various images that appears on the background), the user may use the lower box. To add a Secondary or Processing RAI, the user may enter the RAI SES number at a space 207 and click “ADD.” Then, the user will be able to place the added RAI on the nSITE. Once satisfied, the user may click Publish 226 to upload the finished nSITE to the Server 103. For sending a Primary RAI, the user may use the button Send To 225 and select the contact of choice.

Referring to FIG. 2D, a screen shot illustrating aspects of graphical user interface that facilitates organization of icons in accordance with aspects of the present disclosure is shown. On the “My RAIs,” the user can create groups in order to organize the RAIs depending on the particular purpose. For example, a clothing retailer may create groups according to seasons (e.g., Group A for spring collection; Group B for summer collection; etc.). Likewise, a fast food restaurant may create groups according to the menu (e.g., Group A for hamburgers; Group B for special coffees; etc.). Imported RAIs shows all of the RAIs that were sent to providers.

The VOD 106 and LIVE 105 are platforms utilized for different functionalities depending on the situation. Application of graphical user interface for VOD 106 and LIVE 105 are discussed in detail below.

The VOD 106 is a video on demand platform that enables users to watch video on demand (i.e., Disney Plus, Netflix, etc.). A video on demand company may use this platform to receive RAIs and attach them to specific location of the videos. For example, a clothing retail store (i.e., Old Navy) wants to advertise a jacket to users that watch media content on Netflix. First, Old Navy uses the Creator 104 to create an account.

Then, Old Navy enter the Dashboard and click on the “RAI Editor” tab. The Old Navy may click on the Import RAI Media 203 or Import 205 button shown in FIG. 2B. Then, Old Navy selects the file to be used, input RAI information, and click Assign to RAI 204. At this point, RAI SES number is automatically assigned. Then, Old Navy selects the nSITE Editor tab. It will direct Old Navy to a display shown in FIG. 2C, and enters the RAI SES number in the field provided in the box at top left corner 221 and click Load. The RAI information will show up along with the selected image in the RAI Preview. The Old Navy may select a background image that may be used for nSITE at 222 and click Upload. The background image will be displayed in nSITE Preview 224. If the user wishes to upload a media other than the background, the user will select the media at 223 and click Upload. Then, Old Navy enters the SES number for Secondary and/or Processing RAIs in the box 227 and clicks ADD. This would trigger the RAI to appear on nSITE Preview 224 and it will allow Old Navy to position the RAI inside the display space. Once satisfied, Old Navy would click Publish 226 to render and upload the finished nSITE to the Server 103. For Primary RAI, the user would click Send To 225 and select the contact of choice.

Next, Netflix may enter the Dashboard FIG. 2A. Then Netflix clicks Import on the side menu. From the drop-down menu, it will select Contact and RAI desired and click Import. The information is imported from the Server 103. This will add RAI to their RAI Catalog under Imported RAIs FIG. 2D. When Netflix is ready to use the imported RAI, Netflix will open the Dashboard and click Import Media and select the file/source from Netflix's system to load the media. Once loaded, Netflix would then click Add RAI and select the group and RAI Netflix wish to add. The Netflix will place the RAI in the space within the media. When RAI placement is complete, the provider would click “Render & Upload” on the Dashboard to save it to the Server 103. When a viewer starts playback of a video content, it sends a signal to the Provider 102 to retrieve media content from the Server 103. The Server 103 sends the media content with embedded RAIs to the Provider 102, which is sent to the television 101, making it available to the viewers.

In another embodiment, the LIVE 105 platform may be used to receive and attach RAIs to television programs in real time. For example, a creator (e.g. a soft drink manufacturer) uses the Creator 104 to create an account to advertise its product during a telecast of a live baseball game. The soft drink manufacturer will follow the steps described above (i.e., Old Navy example) to create and assign RAIs/nSITEs and send them to Server 103.

A television programming company (i.e., ESPN) may use LIVE 105 to enter the Dashboard of FIG. 2A. From the drop-down menu, ESPN will select the Contact and RAI desired and click Import. The information is imported from the Server 103. This will add RAI to their RAI Catalog under Imported RAIs FIG. 2D. When ESPN is ready to use the imported RAI, ESPN may open the Dashboard and click Import and select the file/source from the provider's computer to load the media. In this case, the media will be a live baseball game. Once loaded, the network would then click Add RAI and select the group and RAI the provider wish to add. The network will place the RAI in the space within the media (i.e., placing the RAI on the soft drink manufacture's logo located above the scoreboard). When RAI placement is complete, ESPN would click “Render & Upload” on the Dashboard to save it to the Server 103. The Server 103 may send a signal to Providers 102 to put on certain advertisement. It may also be programmed to transmit scheduling information for time stamps for when certain advertisement needs to be played. Also the media-service provider example mentioned above, RAIs may be placed during a live event. Upon receiving the media content from the Server 103, the Provider 102 sends the media content with embedded RAIs to the television 101, making it visible to the viewers in real time.

It is noted that the particular configuration of the graphical user interface shown in FIGS. 2A-2D have been provided for purposes of illustration, rather than by way of limitation and that embodiments may include additional components depending on the particular configuration or implementation. Thus, FIGS. 2A-2D are to be understood as illustrating exemplary concepts of the present disclosure.

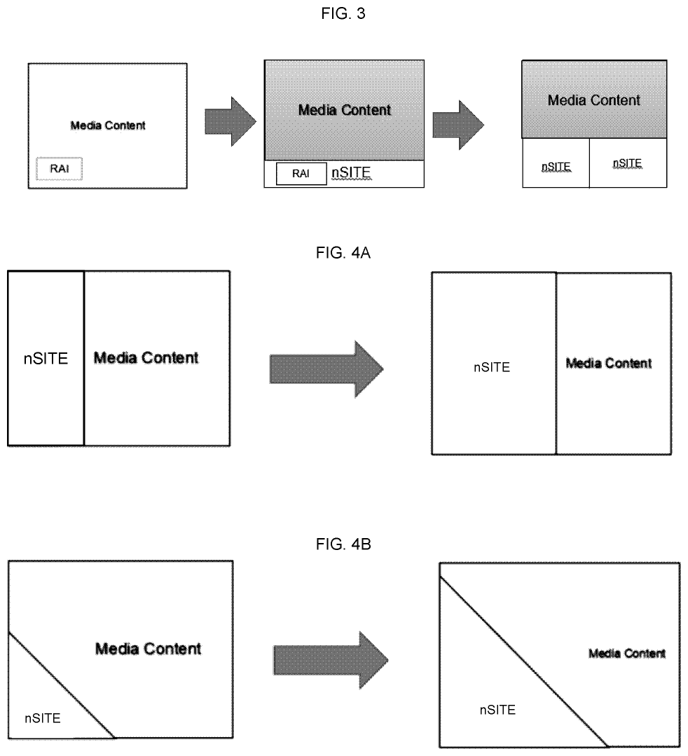

Referring to FIG. 3, screen shots illustrating high-level overview of hierarchical sequence in accordance with aspects of the present disclosure is shown. When a user is viewing the media content, a RAI may appear somewhere on the screen. Although FIG. 3 shows an RAI being displayed on the lower left corner, it is understood that this is for purpose of illustration and that RAIs may be presented at any location within the display space. Upon activation of the RAI, a portion of the screen dynamically resizes to create a second display space for presenting an nSITE corresponding to the activated RAI. As described above, the nSITE may include zero or more additional RAIs. The RAIs may be Secondary or Processing RAIs. When a user clicks on the Secondary or Processing RAIs, a portion of the screen dynamically resizes to create another display space. Although the second nSITE is appears next to the first nSITE in FIG. 3, a user may enable the second nSITE to replace the first nSITE. These configurations may appear simultaneously while the user watches the media content.

It is noted that the particular configuration of the graphical user interface shown in FIG. 3 has been provided for purposes of illustration, rather than by way of limitation and that embodiments may include additional components depending on the particular configuration or implementation. Thus, FIG. 3 is to be understood as illustrating exemplary concepts of the present disclosure.

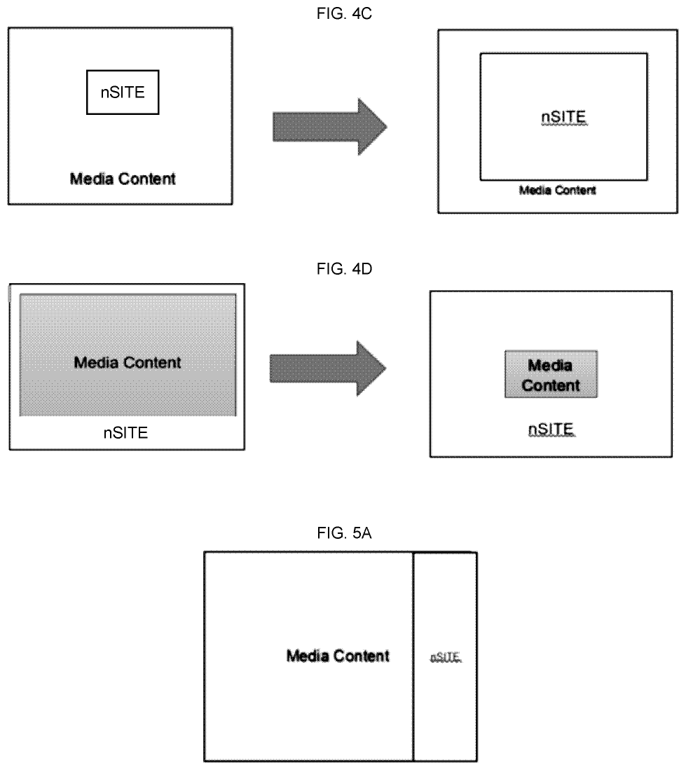

Referring to FIGS. 4A-4D, screen shots illustrating dynamic resizing of the display space with aspects of the present disclosure is shown. First, a viewer sees an RAI in the media content, as shown in FIG. 3. The clicking on the first RAI will trigger dynamic resizing of the display space and presentation of the corresponding nSITE. The nSITE may have additional RAIs to other content within the nSITE that allows the user to navigate the content of the nSITE in the interactive way. The presentation of the nSITE may occur simultaneously with the media content the user was originally viewing such that the media content is not paused or interrupted when the nSITE is displayed. It is noted that while activation of a RAI and presentation of the corresponding nSITE may not interrupt the playback of the media content, the user may pause or stop playback of the media content if desired, such as using a remote control to pause the playback. In such instances, the user may continue to interact with the nSITE and may resume playback of the media content at a time of the user's choosing, such as when the user completes interaction with the nSITE and closes it. In some aspects, if the user pauses the playback of the media content the playback may automatically resume upon the user exiting the nSITE without having to provide commands (e.g., an unpause or play command) using the remote control.

When the RAI is activated by clicking on the icon, it dynamically resizes the display to show the nSITE and the media content simultaneously. For example, a media content may shrink towards the right side of the screen, and the nSITE content can be displayed on the left side of the space. The size of the display space can be dynamically controlled, depending on the purpose. For example, the display space be one fourth of the display, one third of the display, half or the display, or more. The portions of the display space allocated to the nSITE and the media content may be resized to maintain an aspect ratio of the content.

The direction of the resizing may be adjusted in various ways. The dynamic resizing of the display can move horizontally as shown in FIG. 4A. The dynamic resizing of the display can also move diagonally as shown in FIG. 4B. The movement in the diagonal direction may be useful if a user wants to provide an effect of flipping a part of a page (e.g., finding something underneath the page). Further, the display space does not have to touch the outer boundary of the screen. For example, the display space can stand isolated from the outer border like an island. The size of the so-called island may also dynamically increase the screen size, like to a framed painting as shown in FIG. 4C. The resizing of the display in a reverse direction may also be used. In this scenario, the display space is touching the outer boundary of the screen, and it would dynamically resize towards the center of the screen, as shown in FIG. 4D. The speed of the dynamic resizing of the screen may be adjusted depending on purpose.

It is noted that the particular configuration of the dynamic resizing of the display shown in FIGS. 4A-4D have been provided for purposes of illustration, rather than by way of limitation and that embodiments may include additional components depending on the particular configuration or implementation. Thus, FIGS. 4A-4D are to be understood as illustrating exemplary concepts of the present disclosure.

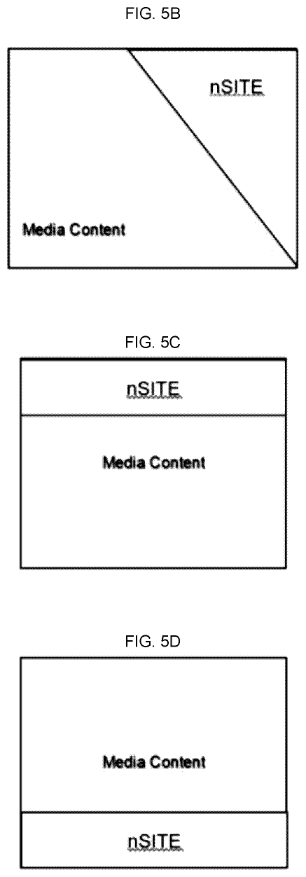

Referring to FIGS. 5A-5D, screen shots depicting examples of locations of the media content displayed with aspects of the present disclosure is shown. The nSITE may be displayed anywhere on the screen depending on the purpose of the commercial entity. On FIG. 5A, the nSITE is placed on the right side of the screen. In another example, an nSITE is placed on the top right of the screen as shown in FIG. 5B. Further, an nSITE may be placed on the top portion of the screen (FIG. 5C) or lower portion of the screen (FIG. 5D).

It is noted that the particular configuration of the locations of the media content displayed shown in FIGS. 5A-5D have been provided for purposes of illustration, rather than by way of limitation and that embodiments may include additional components depending on the particular configuration or implementation. Thus, FIGS. 5A-5D are to be understood as illustrating exemplary concepts of the present disclosure.

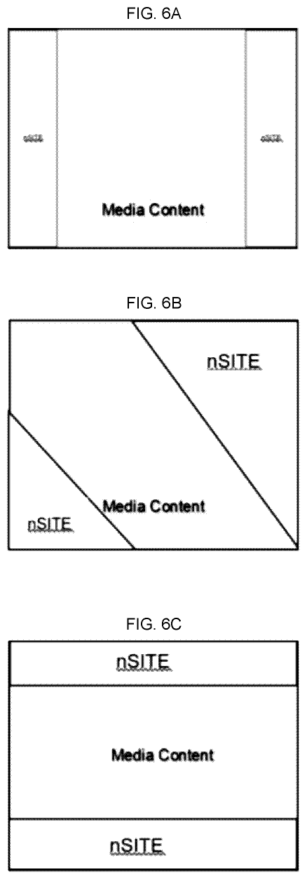

Referring to FIGS. 6A-6C, screen shots depicting examples of pluralities of media content displayed with aspects of the present disclosure is shown. In previous examples, nSITE was placed on one location of the screen. It should be noted that simultaneous resizing of the display may occur at multiple locations on the screen as shown in FIG. 6A. In FIG. 6A, two nSITEs are dynamically resized to move horizontally to create display spaces on the right and the left. Likewise, the dynamically resizing of the screen may occur on diagonal locations as shown in FIG. 6B. It should also be noted on FIG. 6B that, nSITE located on top right is slightly larger than the nSITE located on lower left. In other words, multiple nSITEs do not have to be the same size, and it can be adjusted depending on the purpose of the commercial entities. Another example is shown in FIG. 6C where the nSITEs are placed on top portion and lower portion of the screen.

It is noted that the particular configuration pluralities of media content displayed shown in FIGS. 6A-6C have been provided for purposes of illustration, rather than by way of limitation and that embodiments may include additional components depending on the particular configuration or implementation. Thus, FIGS. 6A-6C are to be understood as illustrating exemplary concepts of the present disclosure.

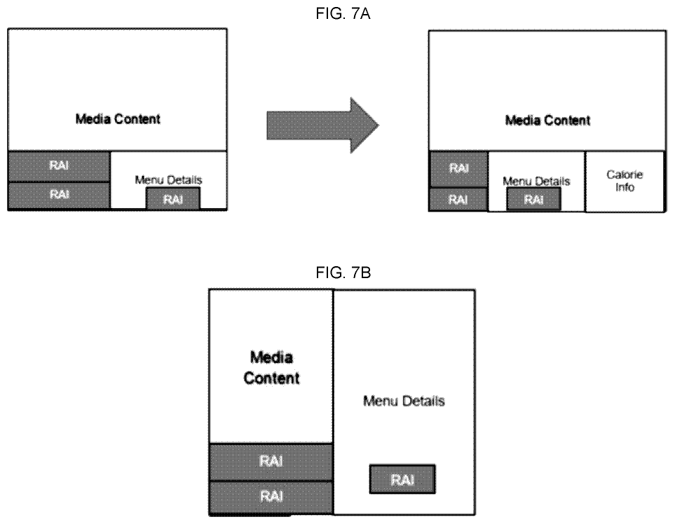

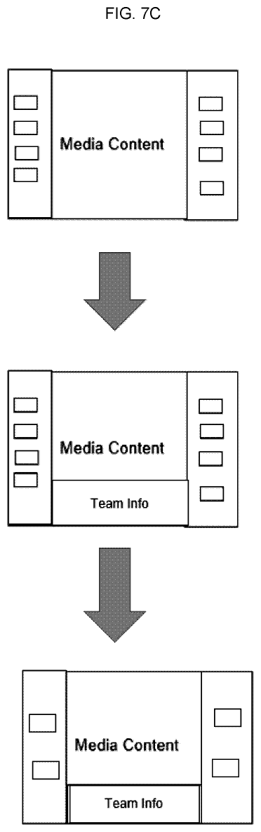

Referring to FIGS. 7A-7B, screen shots depicting examples of pluralities of icons with aspects of the present disclosure are shown. The screen can be split in multiple ways. This configuration would allow further interaction initiated by the viewer. As shown in FIG. 7A, two RAIs are placed on the lower left portion of the screen. Upon a click on one of the RAIs, an nSITE appears on the lower right portion of the screen. This nSITE contains another RAI, which upon activation of the RAI, another resizing of the display is performed that allows another nSITE to appear on another portion of the screen.

For example, a media content shows a TV show where the characters of the TV show are eating, and a primary RAI may appear on the dining table where the characters are eating. Upon activating the Primary RAI, a screen dynamically resizes to create a display at the lower left of the screen. On this screen, two RAIs appear to show Regular and Premium meal choices. These RAIs are called Secondary RAIs, which allows a user to navigate through contents of the nSITEs. When a user clicks on one of the Secondary RAIs, an nSITE opens up by dynamically resizing the display. In this nSITE, menu details may be shown (i.e., ingredients, nutrition information, allergen information, etc.). The nSITE displayed upon clicking the RAI may include a plurality of additional RAIs that the user may activate to view additional information. Upon clicking on the one of the RAIs, a display dynamically resizes to create a display space on the lower right of the screen. On this nSITE, other information may be shown (i.e., calorie information). Additional RAIs (e.g., secondary RAIs) providing access to other information (i.e., recipe, delivery choices, maps, and others) may also be presented. The display size can be arranged to allow more space for the nSITE as shown in FIG. 7B. This configuration may be helpful if the nSITE creator wishes to provide more information on the menu details or to make the content of the nSITE easier to view, such as for configuring the nSITE content for easier viewing on tablet and smartphone computing devices which have smaller display screens.

In another example, a media content shows a basketball game and the commentators are discussing the upcoming basketball tournament bracket. A Primary RAI appears on the screen with the basketball tournament logo. Upon clicking on the Primary RAI, both sides of the screen dynamically resize to create display spaces for two nSITEs, as shown in FIG. 7C. On these nSITEs, a plurality of Secondary RAIs with basketball team logo are displayed. If a user wants to obtain more information on a particular team, the user activates one of the Secondary RAIs corresponding to the particular team. Upon activating the Secondary RAI, a space dynamically resizes to create another display space on the lower center of the screen, which shows the team information with multiple RAIs for each basketball player on the team. When the user clicks on one of the RAIs corresponding to a player, the nSITEs placed on both sides of the screen rearranges to display that player's merchandise. On this screen, several Processing RAI may be placed to purchase the merchandise. Instead of placing the Processing RAI, a commercial entity may place another Secondary RAI to show other information (i.e., map or direction to the nearest store that has the merchandise, etc.).

It is noted that the particular configuration of RAIs and nSITEs shown in FIGS. 7A-7C have been provided for purposes of illustration, rather than by way of limitation and that embodiments may include additional components on the particular configuration or implementation. Thus, FIGS. 7A-7C are to be understood as illustrating exemplary concepts of the present disclosure.

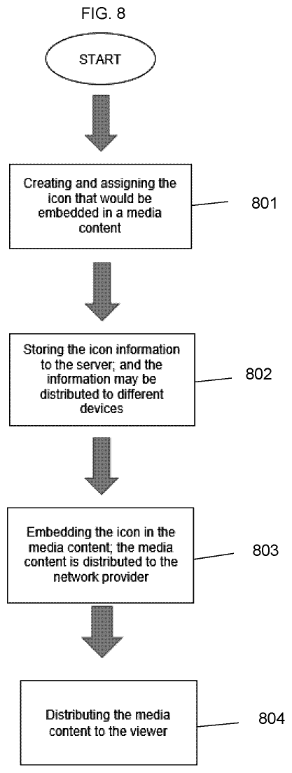

Referring to FIG. 8, a flow diagram of a method for providing dynamic interaction during display of media content according to aspects of the present disclosure is shown. While the various steps in the flowchart are provided and described sequentially, one of ordinary skill will appreciate that some or all of the steps may be executed in different orders, may be combined or omitted, and some or all of the steps may executed in parallel.

Step 801 relates to the initial step where creation and assignment of RAI, as well as creation of nSITE takes place. The RAI that is created at this step may be embedded in a media content. Step 802 relates to sending the RAI information, that was created in step 801, to the Server 103. This enables the various platforms/devices (i.e., Provider 102, Creator 104, LIVE 105, VOD 106) to have access to the information. In other words, the platforms/devices may obtain the RAI information directly from the Server 103. Step 803 relates to a process of embedding the RAI to the media content by LIVE 105 and/or VOD 106. When this process is complete, the information may be sent to the Server 103, which ultimately enables the Provider 102 to obtain the information. Step 804 relates to transmitting media content from the Provider 102 to television 101, which ultimately reaches the viewer.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Those of skill in the art would understand that information and signals to or from the server 103 may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The providers 102, server 103, and the devices (e.g., Creator 104, LIVE 105, VOD 106) described herein may comprise processors, electronics devices, hardware devices, electronics components, logical circuits, memories, software codes, firmware codes, etc., or any combination thereof. In addition, features discussed herein relating to FIGS. 1A-6B may be implemented via specialized processor circuitry, via executable instructions, and/or combinations thereof.

As used herein, various terminology is used for the purpose of describing particular implementations only and is not intended to be limiting. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps (e.g., provider 102, server 103, or devices—Creator 104, LIVE 105, VOD 106) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for providing dynamic interaction during display of media content, the method comprising:
creating and assigning an icon configured to be embedded in a media content, wherein upon activation of the icon, a display space in which media content is presented resizes to create a new display space to show new information;
storing the icon information in the server wherein the icon information is distributed to different devices;
embedding the icon in the media content and sending the information to the server, wherein the information is distributed to the network provider; and
distributing the media content to the viewer, wherein the display of the new display space occurs simultaneously with the broadcasting of a media content.

2. The method of claim 1, wherein a plurality of icons are placed in the media display.

3. The method of claim 1, wherein a plurality of new display space appears on the media display.

4. The method of claim 1, wherein time stamp is sent to the server.

5. The method of claim 1, wherein directions of the resizing are proceeded in various directions.

6. The method of claim 1, wherein size and location of the new display space are adjusted.

7. The method of claim 1, wherein the viewer is interactively engaged with the media content.

8. A system comprising a memory, one or more processors communicatively coupled to the memory to one or more processors can configure to
create and assign an icon configured to be embedded in a media content, wherein upon activation of the icon, a display space in which media content is presented resizes to create a new display space to show new information;
store the icon information in the server wherein the icon information is distributed to different devices;
embed the icon in the media content and send the information to the server, wherein the information is distributed to the network provider; and
distribute the media content to the viewer, wherein the display of the new display space occurs simultaneously with the broadcasting of a media content.

9. The method of claim 1, wherein a plurality of icons are placed in the media display.

10. The method of claim 1, wherein a plurality of new display space appears on the media display.

11. The method of claim 1, wherein time stamp is sent to the server.

12. The method of claim 1, wherein directions of the resizing are proceeded in various directions.

13. The method of claim 1, wherein size and location of the new display space are adjusted.

14. The method of claim 1, wherein the viewer is interactively engaged with the media content.

15. A non-transitory computer readable medium storing instructions that when executed by one or more processors, it causes one or more processors to perform operations for
a method for providing dynamic interaction during display of media content, the method comprising:
creating and assigning an icon configured to be embedded in a media content, wherein upon activation of the icon, a display space in which media content is presented resizes to create a new display space to show new information;
storing the icon information in the server wherein the icon information is distributed to different devices;
embedding the icon in the media content and sending the information to the server, wherein the information is distributed to the network provider; and
distributing the media content to the viewer, wherein the display of the new display space occurs simultaneously with the broadcasting of a media content.

16. The method of claim 1, wherein a plurality of icons are placed in the media display.

17. The method of claim 1, wherein a plurality of new display space appears on the media display.

18. The method of claim 1, wherein time stamp is sent to the server.

19. The method of claim 1, wherein directions of the resizing are proceeded in various directions.

20. The method of claim 1, wherein size and location of the new display space are adjusted.
